(19) United States
(12) Patent Application Publication
(10) Pub. No.: US 2026/0119858 A1
(43) Pub. Date: Apr. 30, 2026

(54) NEURAL NETWORK APPARATUS AND OPERATING METHOD OF THE SAME

(71) Applicant: SAMSUNG ELECTRONICS CO., LTD., Suwon-si (KR)

(72) Inventors: Minyoung MUN, Suwon-si (KR); Seijoon KIM, Suwon-si (KR); Minsik PARK, Suwon-si (KR)

(73) Assignee: SAMSUNG ELECTRONICS CO., LTD., Suwon-si (KR)

(21) Appl. No.: 19/096,104

(22) Filed: Mar. 31, 2025

(30) Foreign Application Priority Data
Oct. 28, 2024 (KR) 10-2024-0148973

(51) Int. Cl. G06N 3/063; G06F 7/544

(52) U.S. Cl. CPC G06N 3/063; G06F 7/5443

(57) ABSTRACT

A neural network apparatus includes at least one control circuit configured to receive input data and weight data from at least one memory, and partition the input data into first input data and second input data, an in-memory computing circuit including an analog crossbar array configured to perform a first multiply-accumulate (MAC) operation based on the first input data and the weight data, and a digital operation circuit configured to perform a second MAC operation based on the second input data and the weight data.

### CROSS-REFERENCE TO RELATED APPLICATION

This application is based on and claims priority under 35 U.S.C. § 119 to Korean Patent Application No. 10-2024-0148973, filed on Oct. 28, 2024, in the Korean Intellectual Property Office, the disclosure of which is incorporated by reference herein in its entirety.

### BACKGROUND

### 1. Field

The disclosure relates to a neural network apparatus and a method of operating the neural network apparatus. More particularly, the disclosure relates to a neural network apparatus that performs a multiply-accumulate (MAC) operation using an in-memory computing circuit and a digital operation circuit, and a method of operating the neural network apparatus.

### 2. Description of the Related Art

A neural network refers to a computational architecture that models the biological brain. With the recent advancement of neural network technology, research is being actively conducted on analyzing input data and extracting valid information therefrom using a neural network apparatus in various types of electronic systems.

The neural network apparatus requires a large amount of operation for complex input data. In order for the neural network apparatus to analyze input data in real time and extract information, technology is required that may efficiently process neural network operations. For example, low-power, high-performance embedded systems, such as smartphones, have limited resources, so technologies are required to decrease accuracy loss while reducing the energy consumption required to process complex input data.

### SUMMARY

Provided is a neural network apparatus and an operating method of the neural network apparatus.

Additional aspects will be set forth in part in the description which follows and, in part, will be apparent from the description, or may be learned by practice of the presented embodiments of the disclosure.

According to an aspect of the disclosure, a neural network apparatus may include: at least one control circuit configured to receive input data and weight data from at least one memory, and partition the input data into first input data and second input data; an in-memory computing circuit including an analog crossbar array configured to perform a first multiply-accumulate (MAC) operation based on the first input data and the weight data; and a digital operation circuit configured to perform a second MAC operation based on the second input data and the weight data.

The input data may include partition information, the partition information indicating a unit and a criterion for partitioning the input data. The at least one control circuit may be configured to perform the input data into the first input data and the second input data, based on the partition information.

The input data may be partitioned into tile units. The at least one control circuit may be configured to classify the partitioned input data into the first input data or the second input data, based on criticality of the tile units, indicating whether each of the tiles unit belongs to a region of interest (ROI).

The input data may be partitioned into layer units. The at least one control circuit may be configured to classify the partitioned input data into the first input data or the second input data, based on sensitivity of the layer units.

The input data may be partitioned into bit units. The at least one control circuit may be configured to classify the partitioned input data into the first input data or the second input data, based on significance of the bit units, indicating how close each of the bit units is to a most significant bit (MSB) and a least significant bit (LSB) of the bit units.

According to another aspect of the disclosure, a method of operating a neural network apparatus includes receiving input data and weight data from at least one memory, partitioning the input data into first input data and second input data, performing a first MAC operation using the first input data and the weight data, by using an analog crossbar array, and performing a second MAC operation using the second input data and the weight data, by using a digital operation circuit.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating an architecture of a neural network according to an embodiment;

FIG. 2 is a diagram illustrating operations being performed in a neural network according to an embodiment;

FIG. 3 is a diagram illustrating an in-memory computing circuit according to an embodiment;

FIG. 4 is a block diagram of a neural network apparatus according to an embodiment;

FIG. 5 is a block diagram of a neural network apparatus according to another embodiment;

FIG. 6 is a diagram illustrating a process in which operations are performed in an in-memory computing circuit, according to an embodiment;

FIG. 7 is a diagram illustrating a process of partitioning input data, according to an embodiment;

FIG. 8 is a diagram illustrating a process of partitioning input data, according to another embodiment;

FIG. 9 is a flowchart illustrating a method of operating a neural network apparatus, according to an embodiment;

FIG. 10 is a flowchart specifically illustrating a process of partitioning input data of S920 into first input data and second input data; and

FIG. 11 is a block diagram of an electronic device according to embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

The terms used in embodiments are selected from commonly used terms as much as possible while considering functions in the embodiments, but the terms may vary depending on the intention of one of ordinary skill in the art, precedents, the emergence of new technologies, etc. Additionally, in certain cases, terms are arbitrarily selected, and in these cases, their meanings will be described in detail in the description section for the relevant embodiment. Therefore, the terms used in the present embodiments should be defined based on the meaning of the terms and the overall content of the embodiments, rather than simply the names of the terms.

In the description of embodiments, when it is described that a part is connected to another part, this includes not only cases where they are directly connected to each other, but also cases where they are electrically connected with another component therebetween. Singular expressions include plural expressions unless the context clearly indicates otherwise. Additionally, when a part is described to “include” a component, this does not mean that it excludes other components, but rather that it may further include other components, unless otherwise specifically stated.

The terms “comprise” or “comprising” used in embodiments should not be construed to necessarily include all of the components or steps described herein, but rather to mean that some of the components or steps may not be included, or that additional components or steps may be included.

Additionally, terms including ordinal numbers, such as “first” or “second,” used herein may be used to describe various components, but the components should not be limited by the terms. The terms may be used to distinguish one component from another component.

The description of the following embodiments should not be construed as limiting the scope of the claims, and what may be easily inferred by one of ordinary skill in the art should be construed as falling within the scope of the rights of the embodiments. Hereinafter, embodiments for illustrative purposes only will be described in detail with reference to the attached drawings.

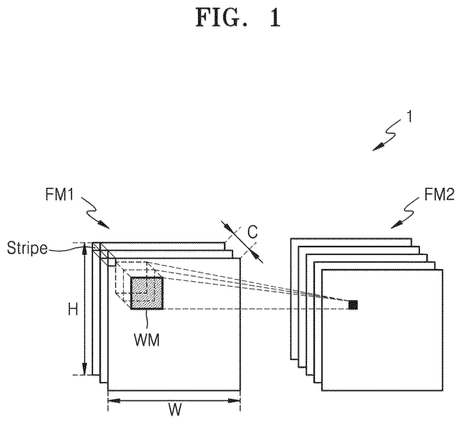

FIG. 1 is a diagram illustrating an architecture of a neural network 1 according to an embodiment.

Referring to FIG. 1, the neural network 1 may be expressed as a machine learning model using nodes and edges. The neural network 1 may be an architecture of a deep neural network (DNN) or an n-layers neural network. The DNN or the n-layers neural network may correspond to a convolutional neural network (CNN), a recurrent neural network (RNN), a deep belief network (DBN), a restricted Boltzmann machine (RBM), etc. For example, the neural network 1 may be implemented as the CNN, but is not limited thereto. The neural network 1 of FIG. 1 may correspond to some layers of the CNN. Therefore, the neural network 1 may correspond to a convolution layer, a pooling layer, a fully connected layer, etc. of the CNN.

In the convolution layer, a first feature map FM1 may correspond to an input feature map, and a second feature map FM2 may correspond to an output feature map. A feature map may refer to a data set in which various features of input data are expressed. The first and second feature maps FM1 and FM2 may be high-dimensional matrices of two or more dimensions, and each may have its own activation parameters. When the first and second feature maps FM1 and FM2 correspond to, for example, 3-dimensional feature maps, the first and second feature maps FM1 and FM2 may have a width W (or called as a column), a height H (or called as a row), and a depth C. At this time, the depth C may correspond to the number of channels.

The first feature map FM1 may include a plurality of input stripes. For example, the first feature map FM1 may include H×W input stripes. An input stripe may refer to channel-wise input data for one space of an input feature map, and may have a size of 1×1×C. For example, the input stripe may include C input activations.

In the convolution layer, convolution operation may be performed on the first feature map FM1 and a weight map WM, and as a result, the second feature map FM2 may be generated. The weight map WM may filter the first feature map FM1 and may be referred to as a weight filter or a weight kernel. In an example, a depth of the weight map WM, i.e., the number of channels, may be equal to the depth C of the first feature map FM1, i.e., the number of channels. The weight map WM may be shifted by traversing the first feature map FM1 using a sliding window. During each shift, each of the weights included in the weight map WM may be multiplied with and added to all feature values in an area overlapping the first feature map FM1. As the weight map WM is convolved with the first feature map FM1, one channel of the second feature map FM2 may be generated.

Although one weight map WM is illustrated in FIG. 1, in reality, a plurality of weight maps may be convolved with the first feature map FM1 to generate a plurality of channels in the second feature map FM2. Meanwhile, the second feature map FM2 of the convolution layer may be an input feature map of a next layer. For example, the second feature map FM2 may be an input feature map of the pooling layer. However, the second feature map FM2 is not limited thereto.

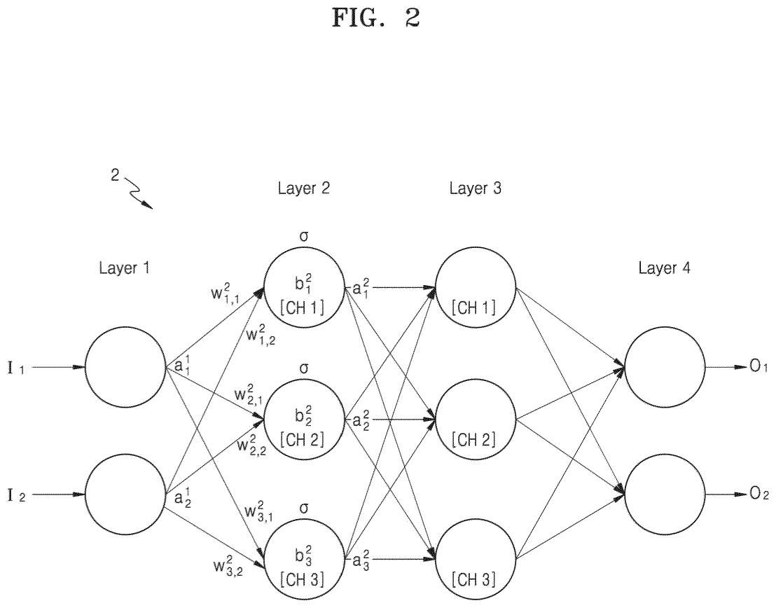

FIG. 2 is a diagram illustrating operations being performed in a neural network 2 according to an embodiment.

Referring to FIG. 2, the neural network 2 may have a structure including an input layer, hidden layers, and an output layer, and may perform operations based on received input data (e.g., I₁ and I₂) and generate output data (e.g., O₁ and O₂) based on results of the operations.

The neural network 2 may include the DNN including two or more hidden layers, or the n-layers neural network, as described above. For example, as illustrated in FIG. 2, the neural network 2 may be the DNN including an input layer “Layer 1”, two hidden layers “Layer 2 and Layer 3”, and an output layer “Layer 4”. When the neural network 2 is implemented with an architecture of the DNN, since the neural network 2 may include more layers that may process valid information, the neural network 2 may process more complex data sets than a neural network with a single layer. Meanwhile, the neural network 2 is illustrated as including four layers in FIG. 2, but this is only an example and the neural network 2 may include fewer or more layers or fewer or more channels. In addition, the neural network 2 may include layers of various structures different from those illustrated in FIG. 2.

Each of the layers included in the neural network 2 may include a plurality of channels. The channel may correspond to a plurality of artificial nodes, known as neurons, processing elements (PE), units, or other similar terms. For example, as illustrated in FIG. 2, Layer 1 may include two channels (or nodes), and Layer 2 and Layer 3 may each include three channels. However, this is only an example and each layer included in the neural network 2 may include a different number of channels (or nodes).

The channels included in each layer of the neural network 2 may be connected to each other to process data. For example, one channel may receive data from other channels, perform operations based on received data, and output the results of the operations to still other channels.

An input and an output of each of the channels may be referred to as input activation and output activation, respectively. That is, an activation may be a parameter corresponding to both the output of one channel and the input of the channels included in the next layer. Meanwhile, each of the channels may determine its own activation based on activations and weights received from the channels included in the previous layer. A weight may be a parameter used to calculate the output activation in each channel and may be a value assigned to connection relationship between channels.

Each of the channels may be processed by a computational unit or a processing element that receives the input and outputs output activations, and the input and output of each of the channels may be mapped to each other. For example, when σ is an activation function,

$${w}_{jk}^{i}$$

is a weight from a k-th channel included in an (i-1)-th layer to a j-th channel included in an i-th layer,

$${b}_{j}^{i}$$

is a bias of the j-th channel included in the i-th layer, and

$${a}_{j}^{i}$$

is an activation of the j-th channel of the i-th layer, the activation

$${a}_{j}^{i}$$

may be calculated using the following mathematical formula 1.

$${a}_{j}^{i} = σ ( {\sum }_{k} ( {w}_{jk}^{i} \times {a}_{k}^{i - 1} ) + {b}_{j}^{i} ) \qquad [ Mathematical Formula 1 ]$$

As illustrated in FIG. 2, the activation of a first channel CH 1 of the second layer Layer 2 may be expressed as

$${a}_{1}^{2} .$$

### Additionally,

$${a}_{1}^{2}$$

may have a value of

$${a}_{1}^{2} = σ ( {w}_{1 , 1}^{2} \times {a}_{1}^{1} + {w}_{1 , 2}^{2} \times {a}_{2}^{1} + {b}_{1}^{2} )$$

according to the mathematical formula 1. The activation function σ may include, but is not limited thereto, a rectified linear unit (ReLU). For example, the activation function σ may include a sigmoid function, a hyperbolic tangent (tanh) function, a maxout function, etc.

As described above, in the neural network 2, numerous data sets may be exchanged between multiple interconnected channels, and undergo computational processes as the data sets pass through layers. In this type of computational process, numerous multiply-accumulate (MAC) operations may be performed, and numerous memory access operations may be performed together to load the activation and weight, which are operands of the MAC operation, at an appropriate time.

Meanwhile, typical digital computers, in which a computational unit and memory are separated, may utilize the von Neumann architecture, which includes a common data bus for data transmission between two separated blocks. Therefore, in a process of implementing the neural network 2 in which data movements and calculations are continuously repeated, a lot of time may be required for data transmission and excessive power may be consumed. To address these issues, the in-memory computing circuit was proposed as an architecture that integrates the computational unit and memory, in order to perform the MAC operation.

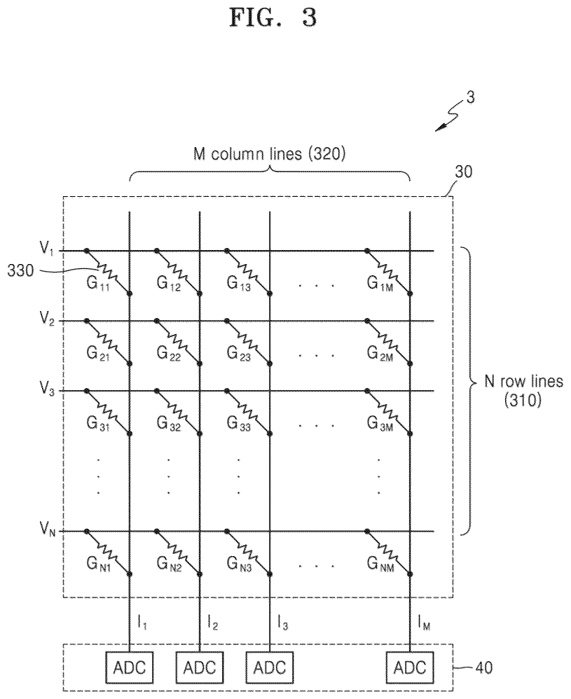

FIG. 3 is a diagram illustrating an in-memory computing circuit 3 according to an embodiment. Referring to FIG. 3, the in-memory computing circuit 3 may include an analog crossbar array 30 and an analog-to-digital converter (ADC) 40. However, the in-memory computing circuit 3 illustrated in FIG. 3 only illustrates components related to the present embodiments. Therefore, it is obvious to one of ordinary skill in the art that the in-memory computing circuit 3 may include other general-purpose components in addition to the components illustrated in FIG. 3.

The analog crossbar array 30 may include a plurality of row lines 310, a plurality of column lines 320, and a plurality of memory cells 330. The plurality of row lines 310 may be used to receive input data. For example, when the plurality of row lines 310 are N row lines (wherein N is any natural number), voltages V₁, V₂, . . . , and V_{N} corresponding to input activations may be applied to the N row lines, respectively. The plurality of column lines 320 may intersect the plurality of row lines 310. For example, when the plurality of column lines 320 are M column lines (wherein M is any natural number), the plurality of column lines 320 and the plurality of row lines 310 may intersect at N×M intersection points.

Meanwhile, the plurality of memory cells 330 may be arranged at the intersection points of the plurality of row lines 310 and the plurality of column lines 320. Each of the plurality of memory cells 330 may be implemented as a non-volatile memory, such as resistive random access memory (ReRAM), embedded flash (eFlash), etc., to store weights, but is not necessarily limited thereto. Each of the plurality of memory cells 330 may include a volatile memory, such as static random access memory (SRAM).

In the example illustrated in FIG. 3, the plurality of memory cells 330 may have conductances G₁₁, G₁₂, G₁₃, . . . , G_{1M}, G₂₁, G₂₂, G₂₃, . . . , G_{2M}, . . . , and G_{NM} corresponding to weights, and when a voltage corresponding to input activation is applied to each of the plurality of row lines 310, a current having a size of I=V×G may be output through each of the plurality of memory cells 330 according to Ohm's law. The currents output from the plurality of memory cells 330 arranged along each column line may be combined with each other, so current sums I₁, I₂, I₃, . . . , and I_{M} may be output along the plurality of column lines 320, respectively. The current sums I₁, I₂, I₃, . . . , and I_{M} may correspond to the results of the MAC operations performed in an analog manner.

The ADC 40 may convert the results of analog MAC operations (i.e., current sums I₁, I₂, I₃, . . . , I_{M}), output from the analog crossbar array 30, into digital signals. The results of the MAC operations, converted into the digital signals, may be output from the ADC 40 and then may be used in a subsequent neural network operation process.

Meanwhile, since the weights are stored in advance in the plurality of memory cells 330, the in-memory computing circuit 3 of FIG. 3 may not require an additional process for reading out the weights. However, since the size of a weight kernel is fixed in advance, it is difficult to efficiently perform operations based on the weight kernel having various sizes rather than operations based on the weight kernel having a specific size.

In addition, when additional digital MAC operations are performed to improve accuracy, conversion from analog signals to digital signals may occur more frequently in the in-memory computing circuit 3, so energy efficiency decreases.

Accordingly, the disclosure provides a neural network apparatus that may improve energy efficiency by accumulatively storing the results of operations of the analog crossbar array in the plurality of memory cells, and may improve accuracy by appropriately dividing and performing the MAC operations in the in-memory computing circuit and the digital operation circuit. Hereinafter, a method of performing MAC operations by the neural network apparatus according to the disclosure will be described with reference to the drawings.

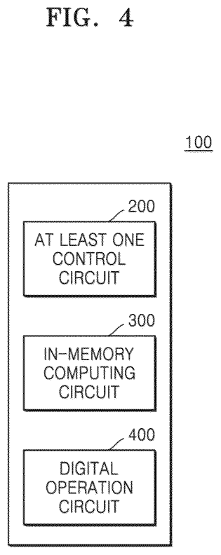

FIG. 4 is a block diagram of a neural network apparatus 100 according to an embodiment. Referring to FIG. 4, the neural network apparatus 100 may include at least one control circuit 200, an in-memory computing circuit 300, and a digital operation circuit 400. However, the neural network apparatus 100 of FIG. 4 only includes components related to the present embodiments, and it is obvious to one of ordinary skill in the art that other general components may be included, in addition to the components illustrated in FIG. 4.

The at least one control circuit 200 may perform overall functions of controlling the neural network apparatus 100. For example, the at least one control circuit 200 may control operations of the in-memory computing circuit 300 and the digital operation circuit 400. Meanwhile, the at least one control circuit 200 may be implemented as an array of a plurality of logic gates, and may also be implemented as a combination of a general-purpose microprocessor and a memory in which a program that may be executed in the microprocessor is stored.

The at least one control circuit 200 may receive input data and weight data from at least one memory. For example, the at least one control circuit 200 may receive input data and weight data from the at least one memory outside the neural network apparatus 100.

The input data and the weight data may be stored in the at least one memory. For example, the input data and the weight data may be stored in different memories, but are not limited thereto, and the input data and the weight data may be stored in a same memory. Meanwhile, the input data and the weight data may be data input to the neural network apparatus 100, and may include an activation and a weight, which are operands for performing the MAC operations, respectively.

The at least one control circuit 200 may partition input data into first input data and second input data. For example, the at least one control circuit 200 may partition the input data, and then transmit the first input data to the in-memory computing circuit 300 and transmit the second input data to the digital operation circuit 400. However, the at least one control circuit 200 may not necessarily have to meaningfully partition the input data. As another example, the at least one control circuit 200 may transmit all of the input data to either the in-memory computing circuit 300 or the digital operation circuit 400.

Additionally, the at least one control circuit 200 may transmit the weight data to the in-memory computing circuit 300 and the digital operation circuit 400. In addition, the at least one control circuit 200 may transmit all of the weight data to either the in-memory computing circuit 300 or the digital operation circuit 400. Alternatively, the at least one control circuit 200 may partition the weight data into first weight data and second weight data and then transmit the same to the in-memory computing circuit 300 and the digital operation circuit 400, respectively.

The in-memory computing circuit 300 may include an analog crossbar array. The analog crossbar array may perform a first MAC operation based on received input data and weight data. The first MAC operation of the disclosure may refer to a MAC operation performed in the in-memory computing circuit 300, and specifically, the first MAC operation may refer to a MAC operation that is performed using the analog crossbar array.

For example, the analog crossbar array may receive the first input data and the weight data from the at least one control circuit 200 and perform the first MAC operation based thereon. Alternatively, as another example, the analog crossbar array may receive the input data and the first weight data from the at least one control circuit 200 and perform the first MAC operation based thereon.

The digital operation circuit 400 may perform a second MAC operation based on the received input data and weight data. The second MAC operation of the disclosure may refer to a MAC operation performed in the digital operation circuit 400. For example, the digital operation circuit 400 may perform the second MAC operation using a look-up table in which results of multiplication operations corresponding to the input data and the weight data are stored in advance. However, a process by which the second MAC operation is performed is not limited thereto, and the digital operation circuit 400 may actually perform the second MAC operation based on the input data and the weight data.

When receiving the second input data and the weight data from the at least one control circuit 200, the digital operation circuit 400 may perform the second MAC operation based on the second input data and the weight data, but this is only one example. As another example, the digital operation circuit 400 may also receive the input data and the second weight data from the at least one control circuit 200 and perform the second MAC operation based thereon.

The at least one memory storing input data and weight data may be placed outside the neural network apparatus 100, but is not limited thereto. Depending on embodiments, the at least one memory storing the input data and the weight data may be placed inside the neural network apparatus 100.

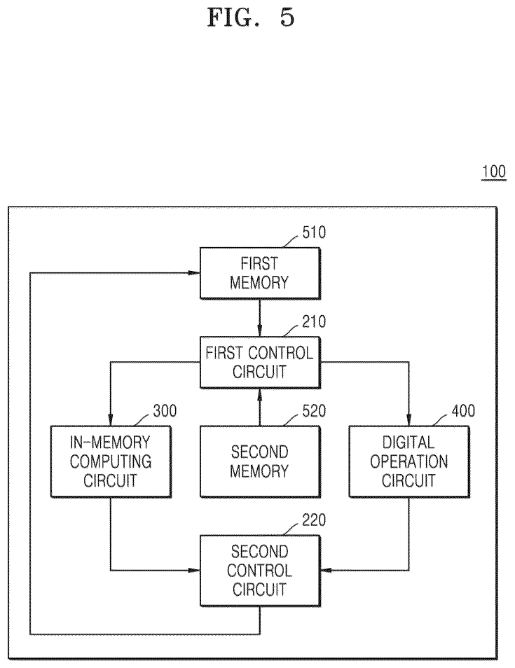

FIG. 5 is a block diagram of a neural network apparatus 100 according to another embodiment. Referring to FIG. 5, the neural network apparatus 100 according to another embodiment may include a first control circuit 210, a second control circuit 220, the in-memory computing circuit 300, the digital operation circuit 400, a first memory 510, and a second memory 520.

The neural network apparatus 100 of FIG. 5 may differ only in the arrangement structure of some components thereof, from the neural network apparatus 100 of FIG. 4. For example, the neural network apparatus 100 of FIG. 5 may be the neural network apparatus 100 to which the first memory 510 and the second memory 520 are added to the neural network apparatus 100 of FIG. 4, and the first control circuit 210 and the second control circuit 220 of FIG. 5 may be each an illustration of a configuration that is obtained by separating the at least one control circuit 200 of FIG. 4.

The first control circuit 210 may receive input data from the first memory 510, and then transmit some of the input data to the in-memory computing circuit 300 and the remainder thereof to the digital operation circuit 400. That is, the first control circuit 210 may partition the input data received from the first memory 510 into first input data and second input data, and then transmit the first input data and the second input data to the in-memory computing circuit 300 and the digital operation circuit 400, respectively.

At this time, the first control circuit 210 may be implemented as an array of a plurality of logic gates controlling an operation of the neural network apparatus 100. However, the disclosure is not limited thereto, and the first control circuit 210 may be implemented as a combination of a general-purpose microprocessor and a memory storing a program that may be executed on the microprocessor. Additionally, the first memory 510 may be implemented as a volatile memory, such as SRAM, to store input data.

The input data stored in the first memory 510 may further include partition information. The partition information of the disclosure may refer to information required to partition input data into the first input data and the second input data. For example, the partition information may include a unit and a criterion for partitioning the input data.

Specifically, the partition information may include information that may determine whether to partition input data into bit units, tile units, or layer units. However, the units for partitioning the input data included in the partition information are not limited to the examples described above. The partition information may also include information that may determine whether to partition input data by unit of filters included in a layer.

Additionally, the partition information may include information that may determine whether partitioned input data has a significant impact on the performance of the neural network apparatus 100. For example, the partition information may include information that may determine whether the partitioned input data is a region vulnerable or sensitive to noise. That is, the partition information may include information that may determine whether the partitioned input data includes a vulnerable parameter.

For example, when the input data is partitioned into bit units, the partition information may include information that may determine whether a targeted bit is most significant bit (MSB) or least significant bit (LSB). At this time, the MSB may be an area having a relatively large impact on the performance of the neural network apparatus 100, and the LSB may be an area having a relatively small impact on the performance of the neural network apparatus 100.

As another example, when the input data is partitioned into tile units, the partition information may include information that may determine whether a targeted tile is a critical tile or not. At this time, the critical tile may be an area having a relatively large impact on the performance of the neural network apparatus 100, and a non-critical tile may be an area having a relatively small impact on the performance of the neural network apparatus 100.

For example, the critical tile may be a tile including a region of interest (ROI), and the non-critical tile may be a tile including a region of not interest (RONI). For another example, the critical tile may be a tile that includes an event region, which is a region where changes are relatively large compared to previous input data, and the non-critical tile may be a tile that includes an edge region, which is a region where changes are relatively small compared to the previous input data.

As another example, when the input data is partitioned into layer units, the partition information may include information that may determine whether a targeted layer is a sensitive layer or not. At this time, the sensitive layer may be an area having a relatively large impact on the performance of the neural network apparatus 100, and a non-sensitive layer may be an area having a relatively small impact on the performance of the neural network apparatus 100. For example, the sensitivity of a layer may be determined based on a gradient magnitude of the layer. Layers with larger gradients (compared to other layers) may be considered more sensitive because their weights have a significant impact on the output. Conversely, layers with smaller gradients (close to zero) may be considered less sensitive, suggesting they have minimal influence on the output and may be less critical for learning. In another example, the sensitivity of a layer may be determined by measuring how changes in the activations of a layer affect the final prediction of the neural network. If a small change in the activation of the layer leads to a large change in the final prediction, that layer may be considered more sensitive. If the change has little effect on the output, the layer may be considered less sensitive.

For example, in the convolutional layer, when a first layer that receives input data for the first time, and a fully connected layer that performs classification are relatively sensitive layers, the first layer and the fully connected layer may be the sensitive layer, and the other layers may be the non-sensitive layer.

The first control circuit 210 may partition the input data into the first input data and the second input data, based on the partition information. The first control circuit 210 may determine whether the input data partitioned into specific units, based on the partition information, has a significant impact on the performance of the neural network apparatus 100. The first control circuit 210 may classify the partitioned input data as the first input data when the partitioned input data has a relatively small impact on the performance of the neural network apparatus 100, and may classify the partitioned input data as the second input data when the partitioned input data has a relatively large impact on the performance of the neural network apparatus 100.

For example, the first control circuit 210 may classify the MSB as the second input data and the LSB as the first input data, depending on the significance of the targeted bit. As another example, the first control circuit 210 may classify the critical tile as the second input data and other tiles as the first input data, depending on the criticality of the targeted tile. As another example, the first control circuit 210 may classify the sensitive layer as the second input data and other layers as the first input data, depending on the sensitivity of the targeted layer.

The first control circuit 210 may partition the input data into the first input data and the second input data, based on the partition information, and then transmit the first input data to the in-memory computing circuit 300 and the second input data to the digital operation circuit 400, respectively.

The first control circuit 210 may further receive the weight data from the second memory 520. According to an embodiment, the first control circuit 210 may partition the received weight data into the first weight data and the second weight data, and then transmit the first weight data and the second weight data to the in-memory computing circuit 300 and the digital operation circuit 400, respectively. At this time, the second memory 520 may be implemented as a volatile memory, such as SRAM, to store the weight data.

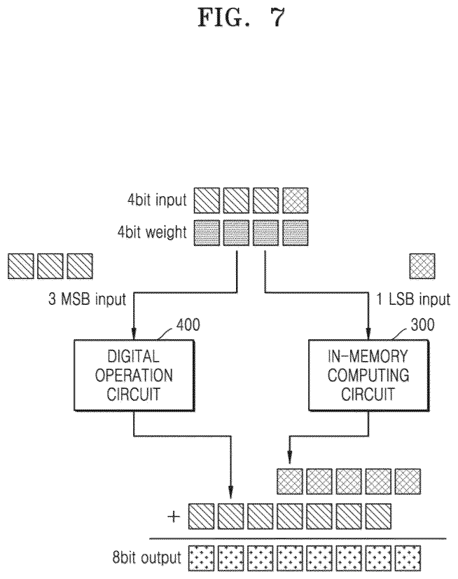

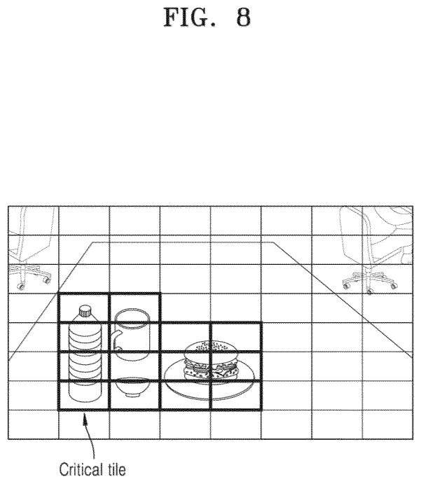

Hereinafter, with reference to FIGS. 7 and 8, the process of partitioning the input data by the first control circuit 210 will be specifically described.

FIG. 7 is a diagram illustrating the process of partitioning the input data, according to an embodiment, and FIG. 8 is a diagram illustrating the process of partitioning the input data, according to another embodiment.

Referring to FIG. 7, it may be seen that the input data consists of a total of 4 bits, including of 3 MSBs and 1 LSB, and the weight data also consists of a total of 4 bits. The first control circuit 210 may receive 4-bit input data from the first memory 510 and 4-bit weight data from the second memory 520.

The first control circuit 210 may classify 3 MSBs as the second input data and 1 LSB as the first input data, based on the partition information included in the input data. The first control circuit 210 may partition the total of 4 bits of input data into 3 bits of the second input data and 1 bit of the first input data.

The first control circuit 210 may transmit the second input data and the weight data to the digital operation circuit 400 and transmit the first input data and the weight data to the in-memory computing circuit 300. Accordingly, the digital operation circuit 400 may perform the MAC operation on the MSB, and the in-memory computing circuit 300 may perform the MAC operation on the LSB.

When the neural network apparatus 100 partitions the input data into bit units, the MAC operation on the MSB may be performed in the digital operation circuit 400 and the MAC operation on the LSB may be performed in the in-memory computing circuit 300, thereby efficiently improving the accuracy of the neural network apparatus 100.

Although not illustrated, the first control circuit 210 may transmit the input data and the second weight data to the digital operation circuit 400 and transmit the input data and the first weight data to the in-memory computing circuit 300.

The first control circuit 210 may classify the weight data corresponding to 3 MSBs into the second weight data and classify the weight data corresponding to 1 LSB into the first weight data, based on the partition information included in the input data. That is, the first control circuit 210 may partition the total 4 bits of weight data into 3 bits of the second weight data and 1 bit of the first weight data.

The first control circuit 210 may transmit the input data and the second weight data to the digital operation circuit 400 and transmit the input data and the first weight data to the in-memory computing circuit 300, thereby similarly allowing the MAC operation on the MSB to be performed in the digital operation circuit 400 and the MAC operation on the LSB to be performed in the in-memory computing circuit 300.

Meanwhile, FIG. 7 only illustrates a process in which 4-bit input data is partitioned into 3 MSB and 1 LSB, and the MAC operation is performed based on each of the partitioned bits and 4-bit weight data. However, the total number of bits of the input data and the weight data, and the number of the MSB and the LSB into which the input data is partitioned are not limited thereto. Depending on embodiments, the input data and the weight data may each include a total of two bits, in which case the input data may be partitioned into 1 MSB and 1 LSB.

Referring to FIG. 8, it may be seen that the input data includes a total of 64 tiles, of which only 14 tiles are critical tiles. Among the total of 64 tiles, 14 tiles may be the critical tiles including the ROI, while the remaining 50 tiles may be the non-critical tiles including the RONI.

The first control circuit 210 may classify 14 critical tiles as the second input data and 50 non-critical tiles as the first input data, based on the partition information included in the input data. That is, the first control circuit 210 may partition the input data that consists of a total of 64 tiles, into the second input data consisting of 14 tiles and the first input data consisting of 50 tiles.

The first control circuit 210 may transmit the second input data and the weight data to the digital operation circuit 400, and transmit the first input data and the weight data to the in-memory computing circuit 300. Accordingly, the digital operation circuit 400 may perform the MAC operation on the critical tiles, and the in-memory computing circuit 300 may perform the MAC operation on the non-critical tiles.

When the neural network apparatus 100 partitions the input data into tile units, the MAC operation on the critical tiles may be performed in the digital operation circuit 400 and the MAC operation on the non-critical tiles may be performed in the in-memory computing circuit 300, thereby efficiently improving the accuracy of the neural network apparatus 100.

That is, the neural network apparatus 100 according to the disclosure may efficiently improve the accuracy of the neural network apparatus 100 by performing computational processes that have a relatively large impact on the performance of the apparatus in the digital operation circuit 400 and performing computational processes that have a relatively small impact thereon in the in-memory computing circuit 300.

Returning to FIG. 5 again, the second control circuit 220 may generate output data by combining a result of the first MAC operation performed in the in-memory computing circuit 300 with a result of the second MAC operation performed in the digital operation circuit 400.

If necessary, the second control circuit 220 may perform post-processing on the result of the first MAC operation and the result of the second MAC operation and then combine the result of the first MAC operation with the result of the second MAC operation. The post-processing performed by the second control circuit 220 on the result of the first MAC operation and the result of the second MAC operation may vary, depending on the units into which the first control circuit 210 partitions the input data.

For example, when the first control circuit 210 partitions the input data into bit units, the second control circuit 220 may further perform a shift operation and an addition operation on the result of the first MAC operation and the result of the second MAC operation. As another example, when the first control circuit 210 partitions the input data into tile units or layer units, the second control circuit 220 may further perform a process of normalizing the result of the first MAC operation and the result of the second MAC operation.

The second control circuit 220 may generate the output data by performing additional necessary post-processing on the result of the first MAC operation and the result of the second MAC operation, and may store generated final output data in the first memory 510.

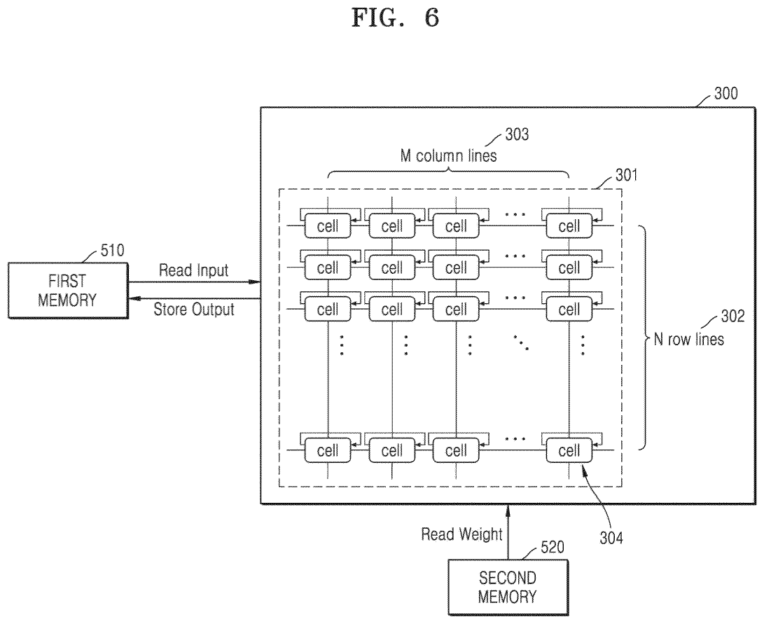

Meanwhile, since the result of the first MAC operation is an analog signal, the result of the first MAC operation needs to be converted into a digital signal by the second control circuit 220, before being combined with the result of the second MAC operation. Hereinafter, with reference to FIG. 6, the process of performing the first MAC operation in the in-memory computing circuit 300 and then converting the results into the digital signal will be specifically described.

FIG. 6 is a diagram illustrating a process in which operations are performed in an in-memory computing circuit 300, according to an embodiment. The in-memory computing circuit 300 of FIG. 6 may receive input data from the first memory 510 and weight data from the second memory 520. For convenience of explanation, the at least one control circuit 200 of FIG. 4 or the first control circuit 210 of FIG. 5 is not illustrated in FIG. 6, but the in-memory computing circuit 300 may receive the input data stored in the first memory 510 and the weight data stored in the second memory 520 through the at least one control circuit 200 of FIG. 4 or the first control circuit 210 of FIG. 5. That is, the in-memory computing circuit 300 of FIG. 6 may receive the first input data, which is the input data partitioned by the first control circuit 210.

Referring to FIG. 6, the in-memory computing circuit 300 according to an embodiment may include an analog crossbar array 301 that performs the first MAC operation, based on the first input data and the weight data. For convenience of explanation, only one analog crossbar array 301 is illustrated in FIG. 6, but the number of analog crossbar arrays 301 is not limited thereto. Depending on embodiments, the in-memory computing circuit 300 may include a plurality of analog crossbar arrays 301. Additional components may be incorporated into the in-memory computing circuit 300, even though they are not depicted in FIG. 6.

The analog crossbar array 301 may include a plurality of row lines 302, a plurality of column lines 303, and a plurality of memory cells 304. The plurality of column lines 303 may intersect the plurality of row lines 302. For example, when the plurality of column lines 303 are M column lines (wherein M is any natural number), the plurality of column lines 303 and the plurality of row lines 302 may intersect at N×M intersection points.

The plurality of memory cells 304 may be arranged at intersections of the plurality of row lines 302 and the plurality of column lines 303. The result of the first MAC operation performed at least once by the analog crossbar array 301 may be stored in the plurality of memory cells 304.

For example, when the first input data and the weight data input to the in-memory computing circuit 300 are expressed as matrix A and matrix W, respectively, the in-memory computing circuit 300 may perform the first MAC operation at least once based on the first input data and the weight data, by performing an outer product on two matrices A and W as in the following [Mathematical Formula 2].

$$A \times W = \sum ( {A}_{ik} \times {W}_{kj} ) \qquad [ Mathematical Formula 2 ]$$

Accordingly, the results of multiplying the first input data input along the plurality of row lines 302 and the weight data input along the plurality of column lines 303 may be accumulated and stored in the plurality of memory cells 304.

The in-memory computing circuit 300 may perform the first MAC operation at least once using the analog crossbar array 301, and accordingly, the result of the first MAC operation performed at least once may be accumulated and stored in the plurality of memory cells 304. At this time, the number of times the first MAC operation may be performed may be determined depending on the capacity of the plurality of memory cells 304.

The neural network apparatus 100 may further include an ADC that converts the result of the first MAC operation stored in the plurality of memory cells 304, into the digital signal. For example, the ADC may be included in the in-memory computing circuit (e.g., the in-memory computing circuit 3 of FIG. 3) as illustrated in FIG. 3, but is not limited thereto. As another example, the ADC may be arranged outside of the in-memory computing circuit 300.

The ADC may not be driven every time the first MAC operation is performed in the analog crossbar array 301, but may be driven when multiple first MAC operations are performed in the analog crossbar array 301 and the accumulated results are stored in the plurality of memory cells 304. That is, as the number of times the ADC is driven decreases, the energy efficiency of the neural network apparatus 100 may increase.

As the weights are stored in the second memory 520 rather than in the plurality of memory cells 304, the in-memory computing circuit 300 may flexibly perform the MAC operations for the weight kernels of various sizes. Specifically, since the analog crossbar array 301 may not need to be configured to fit the weight kernel of a specific size, the in-memory computing circuit 300 may efficiently perform the MAC operations for the weight kernels of various sizes.

In addition, as the weights are stored in the second memory 520, not in the plurality of memory cells 304, when the first input data and the weight data are input to the in-memory computing circuit 300, all of the analog crossbar arrays 301 included in the in-memory computing circuit 300 may perform the first MAC operation simultaneously. Accordingly, the amount of operations that the in-memory computing circuit 300 may process within a given time may significantly increase.

The analog crossbar array 301 may perform the first MAC operation at least once using charges. That is, the analog crossbar array 301 may perform the first MAC operation at least once through the movement and accumulation of charges, and charges resulting from the first MAC operation performed at least once may be accumulated and stored in the plurality of memory cells 304. Additionally, the analog crossbar array 301 may utilize charges and thus may perform the first MAC operation for multiple bits. Accordingly, the result of the first MAC operation performed at least once may be stored as multiple bits in the plurality of memory cells 304.

As the analog crossbar array 301 performs the MAC operations based on charge rather than voltage, the analog crossbar array 301 may be less affected by voltage drop that occurs within the in-memory computing circuit 300, and thus the accuracy of the MAC operations of the analog crossbar array 301 may be improved.

That is, the neural network apparatus 100 of the disclosure may accumulate and store the result of the first MAC operation of the analog crossbar array 301 in the plurality of memory cells 304, thereby reducing energy consumption. In addition, the neural network apparatus 100 of the disclosure may improve the accuracy of operation by performing operations based on charges using the analog crossbar array 301.

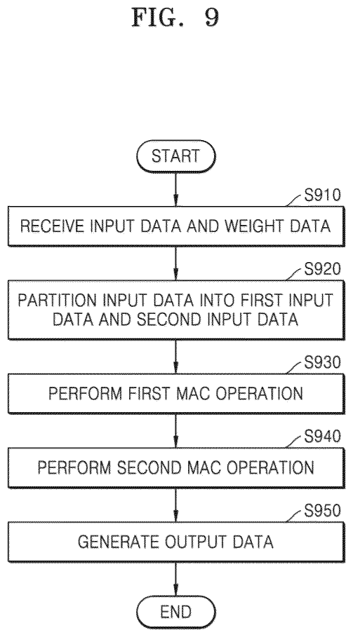

FIG. 9 is a flowchart illustrating a method of operating a neural network apparatus, according to an embodiment. Referring to FIG. 9, the method of operating the neural network apparatus according to an embodiment may include operations processed in the neural network apparatus 100 described with reference to FIGS. 1 to 8. Accordingly, contents described above with respect to the neural network apparatus 100 described with reference to FIGS. 1 to 8 may also be applied to the method disclosed in FIG. 9.

In operation S910, at least one control circuit (e.g., the at least one control circuit 200 of FIG. 4) or a first control circuit (e.g., the first control circuit 210 of FIG. 5) may receive input data stored in at least one memory or a first memory (e.g., the first memory 510 of FIG. 5) and receive weight data stored in at least one memory or a second memory (e.g., the second memory 520 of FIG. 5). The input data and the weight data may be data input to the neural network apparatus 100, and may include an activation and a weight, which are operands for performing the MAC operations, respectively.

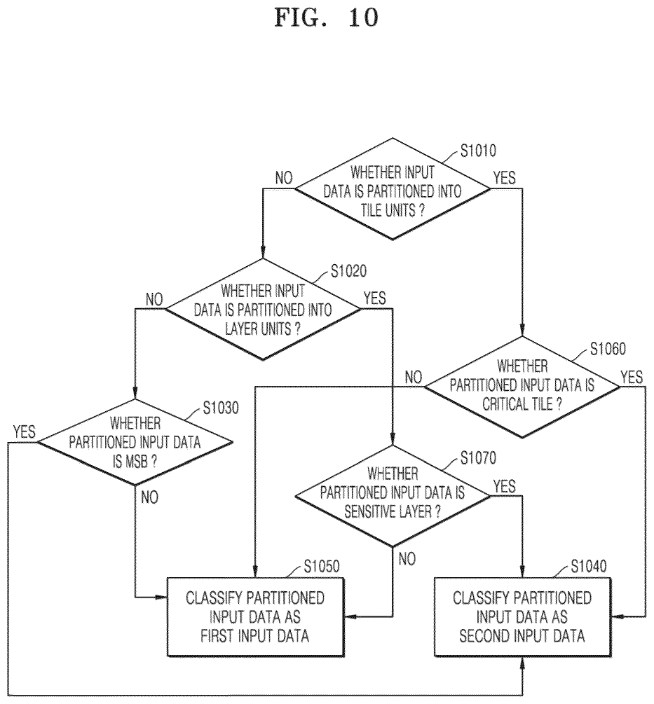

In operation S920, the at least one control circuit 200 or the first control circuit 210 may partition the input data into first input data and second input data. The input data may further include partition information. For example, the partition information may include units and criteria for partitioning the input data. Specifically, the partition information may include information that may determine whether to partition the input data into bit units, tile units, or layer units, and information that may determine whether the partitioned input data is an area that has a large impact on the performance of the neural network apparatus 100. A specific process of partitioning the input data into the first input data and the second input data will be described later with reference to FIG. 10.

The at least one control circuit 200 or the first control circuit 210 may partition the input data, and then transmit the first input data to the in-memory computing circuit 300 and transmit the second input data to the digital operation circuit 400. However, the at least one control circuit 200 may not necessarily have to meaningfully partition the input data. As another example, the at least one control circuit 200 or the first control circuit 210 may transmit all of the input data to the in-memory computing circuit 300 or the digital operation circuit 400.

The at least one control circuit 200 or the first control circuit 210 may transmit the weight data to the in-memory computing circuit 300 and the digital operation circuit 400. In addition, the at least one control circuit 200 or the first control circuit 210 may transmit all of the weight data to either the in-memory computing circuit 300 or the digital operation circuit 400. Alternatively, the at least one control circuit 200 or the first control circuit 210 may partition the weight data into first weight data and second weight data and then transmit the same to the in-memory computing circuit 300 and the digital operation circuit 400, respectively.

In operation S930, the in-memory computing circuit 300 may perform the first MAC operation using the analog crossbar array 301. The in-memory computing circuit 300 may include the analog crossbar array 301 that performs the first MAC operation based on first input data and the weight data.

The analog crossbar array 301 may include the plurality of row lines 302, the plurality of column lines 303, and the plurality of memory cells 304. The plurality of column lines 303 may intersect the plurality of row lines 302. The plurality of memory cells 304 may be arranged at intersections of the plurality of row lines 302 and the plurality of column lines 303. The result of the first MAC operation performed at least once by the analog crossbar array 301 may be accumulated and stored in the plurality of memory cells 304. At this time, the number of times the first MAC operation may be performed may be determined depending on the capacity of the plurality of memory cells 304.

The method of operating the neural network apparatus 100 of the disclosure may accumulate and store the result of the first MAC operation of the analog crossbar array 301 in the plurality of memory cells 304, thereby reducing energy consumption.

As the analog crossbar array 301 performs the MAC operations based on charges rather than voltage, the analog crossbar array 301 may be less affected by voltage drop that occurs within the in-memory computing circuit 300, and thus the accuracy of the MAC operations of the analog crossbar array 301 may be improved. The method of operating the neural network apparatus 100 of the disclosure may improve the accuracy of operation by performing operations based on charges using the analog crossbar array 301.

The ADC may convert the result of the first MAC operation stored in the plurality of memory cells 304 into a digital signal. The ADC may be driven when the first MAC operation is performed at least once in the analog crossbar array 301 and the accumulated result thereof is stored in the plurality of memory cells 304. Accordingly, the energy efficiency of the neural network apparatus 100 may increase.

In operation S940, the digital operation circuit 400 may perform the second MAC operation based on the second input data and the weight data. The digital operation circuit 400 may perform the second MAC operation using a look-up table in which the results of multiplication operations corresponding to the second input data and the weight data are stored in advance. However, the process by which the second MAC operation is performed is not limited thereto, and the digital operation circuit 400 may actually perform the second MAC operation based on the second input data and the weight data.

Alternatively, the digital operation circuit 400 may perform the second MAC operation based on the input data and the second weight data. At this time, the digital operation circuit 400 may perform the second MAC operation using the look-up table in which the results of multiplication operations corresponding to the input data and the second weight data is stored in advance, or may actually perform the second MAC operation based on the input data and the second weight data.

Although FIG. 9 illustrates that S940 is performed after S930, this is merely a distinction made for convenience of explanation, and depending on embodiments, operations S930 and S940 may be performed simultaneously or with a slight time difference.

For example, when the input data is partitioned into bit units or tile units, the in-memory computing circuit 300 may perform the first MAC operation based on the first input data and the weight data and simultaneously the digital operation circuit 400 may perform the second MAC operation based on the second input data and the weight data, using the analog crossbar array 301.

As another example, when input data is divided into layer units or filter units, when the first input data and weight data are transmitted to the in-memory computing circuit 300, the analog crossbar array 301 may perform the first MAC operation, and when the second input data and weight data are transmitted to the digital operation circuit 400, the digital operation circuit 400 may perform the second MAC operation. That is, the second MAC operation may be newly started in the digital operation circuit 400 even before the result of the first MAC operation is output in the in-memory computing circuit 300. Similarly, the first MAC operation may be newly started in the in-memory computing circuit 300 even before the result of the second MAC operation is output in the digital operation circuit 400.

In operation S950, the at least one control circuit 200 or the second control circuit (e.g., the second control circuit 220 of FIG. 5) may generate output data by combining the result of the first MAC operation performed in the in-memory computing circuit 300 with the result of the second MAC operation performed in the digital operation circuit 400.

The at least one control circuit 200 or the second control circuit 220 may combine the result of the first MAC operation with the result of the second MAC operation after performing a post-processing on the results of the first MAC operation and the result of the second MAC operation, if necessary.

For example, when the at least one control circuit 200 or the first control circuit 210 partitions the input data into bit units, the at least one control circuit 200 or the second control circuit 220 may further perform a shift operation and an addition operation on the result of the first MAC operation and the result of the second MAC operation. For another example, when the at least one control circuit 200 or the first control circuit 210 partitions the input data into tile units or layer units, the at least one control circuit 200 or the second control circuit 220 may further perform a process of normalizing the result of the first MAC operation and the result of the second MAC operation.

The at least one control circuit 200 or the second control circuit 220 may generate output data by performing further necessary post-processing on the result of the first MAC operation and the result of the second MAC operation, and then may store the output data generated finally in the first memory 510.

FIG. 10 is a flowchart specifically illustrating a process of partitioning input data of operation S920 into the first input data and the second input data.

In operation S1010, the neural network apparatus 100 may determine whether the input data is partitioned into tile units. When the input data is not partitioned into tile units, in operation S1020, the neural network apparatus 100 may determine whether the input data is partitioned into layer units. When the input data is not partitioned into layer units, the neural network apparatus 100 may determine that the input data is partitioned into bit units.

When the input data is partitioned into bit units, in operation S1030, the neural network apparatus 100 may determine whether targeted bit or partitioned input data is MSB. When the targeted bit is determined to be MSB, in operation S1040, the neural network apparatus 100 may classify the targeted bit as the second input data. On the other hand, when it is determined that the targeted bit or partitioned input data is not MSB, in operation S1050, the neural network apparatus 100 may determine the targeted bit or partitioned input data as LSB and classify the targeted bit or partitioned input data as the first input data.

Again in operation S1010, when the input data is partitioned into tile units, in operation S1060, the neural network apparatus 100 may determine whether the targeted tile or the divided input data is a critical tile. When the targeted tile or the partitioned input data is determined to be the critical tile, in operation S1040, the neural network apparatus 100 may classify the targeted tile or the partitioned input data as the second input data. On the other hand, when it is determined that the targeted tile or the partitioned input data is not the critical tile, in operation S1050, the neural network apparatus 100 may classify the targeted tile or the partitioned input data as the first input data.

Again in operation S1020, when the input data is partitioned into layer units, in S1070, the neural network apparatus 100 may determine whether the targeted layer or the partitioned input data is a sensitive layer. When the targeted layer or the partitioned input data is determined to be the sensitive layer, in operation S1040, the neural network apparatus 100 may classify the targeted layer or the partitioned input data as the second input data. On the other hand, when it is determined that the targeted layer or the partitioned input data is not the sensitive layer, in operation S1050, the neural network apparatus 100 may classify the targeted layer or the partitioned input data as the first input data.

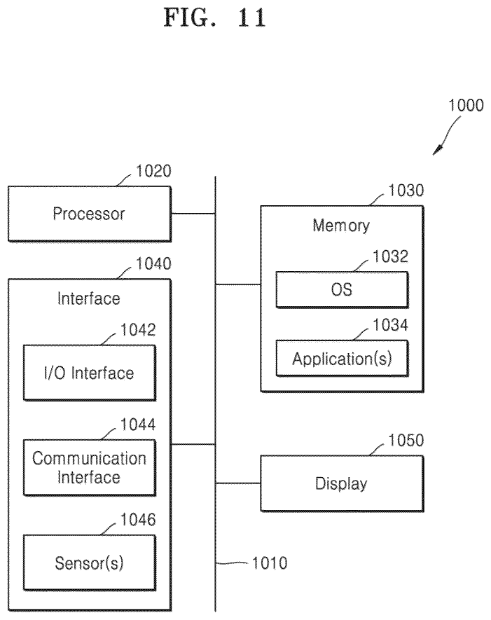

FIG. 11 is a block diagram of an electronic device according to embodiments of the present disclosure.

FIG. 11 is for illustration only, and other embodiments of the electronic device 1000 could be used without departing from the scope of this disclosure. For example, the electronic device 1000 may be implemented as a moving object, such as a vehicle, a robot, or a vacuum cleaner, equipped with a camera for capturing images and videos and a processor for processing image data.

The electronic device 1000 includes a bus 1010, a processor 1020, a memory 1030, an interface 1040, and a display 1050

The bus 1010 includes a circuit for connecting the components 1020 to 1050 with one another. The bus 1010 functions as a communication system for transferring data between the components 1020 to 1050 or between electronic devices.

The processor 1020 includes one or more of a central processing unit (CPU), a graphics processor unit (GPU), an accelerated processing unit (APU), a many integrated core (MIC), a field-programmable gate array (FPGA), or a digital signal processor (DSP). The processor 1020 is able to perform control of any one or any combination of the other components of the electronic device 1000, and/or perform an operation or data processing relating to communication. For example, The neural network apparatus 100 may be implemented using the processor 1020 in conjunction with the memory 1030 to execute operations S910-S950 and S1010-S1070, as illustrated in FIGS. 9 and 10. The processor 1020 executes one or more programs stored in the memory 1030.

The memory 1030 may include a volatile and/or non-volatile memory. The memory 1030 stores information, such as one or more of commands, data, programs (one or more instructions), applications 1034, etc., which are related to at least one other component of the electronic device 1000 and for driving and controlling the electronic device 1000. For example, commands and/or data may formulate an operating system (OS) 1032. Information stored in the memory 1030 may be executed by the processor 1020.

The applications 1034 include the above-discussed embodiments. These functions can be performed by a single application or by multiple applications that each carry out one or more of these functions. For example, the applications 1034 may include artificial intelligence (AI) models for performing operations S910-S950 and S1010-S1070 in FIGS. 9 and 10.

The display 1050 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display.

The interface 1040 includes input/output (I/O) interface 1042, communication interface 1044, and/or one or more sensors 1046. The I/O interface 1042 serves as an interface that can, for example, transfer commands and/or data between a user and/or other external devices and other component(s) of the electronic device 1000.

The communication interface 1044 may include and an antenna and a transceiver to enable communication between the electronic device 1000 and other external devices, via a wired connection, a wireless connection, or a combination of wired and wireless connections. The communication interface 1044 may permit the electronic device 1000 to receive information from another device and/or provide information to another device. For example, the communication interface 1044 may include an Ethernet interface, an optical interface, a coaxial interface, an infrared interface, a radio frequency (RF) interface, a universal serial bus (USB) interface, a Wi-Fi interface, a cellular network interface, or the like.

The sensor(s) 1046 of the interface 1040 can meter a physical quantity or detect an activation state of the electronic device 1000 and convert metered or detected information into an electrical signal. For example, the sensor(s) 1046 can include one or more cameras or other imaging sensors for capturing images of scenes. The sensor(s) 1046 can also include any one or any combination of a microphone, a keyboard, a mouse, and one or more buttons for touch input. The sensor(s) 1046 can further include an inertial measurement unit. In addition, the sensor(s) 1046 can include a control circuit for controlling at least one of the sensors included herein. Any of these sensor(s) 1046 can be located within or coupled to the electronic device 1000.

Although the embodiments have been described in detail above, the scope of the disclosure is not limited thereto, and various modifications and improvements made by those of ordinary skill in the art using the basic concept of the disclosure defined in the following claims also fall within the scope of the disclosure.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A neural network apparatus comprising:
at least one control circuit configured to receive input data and weight data from at least one memory, and partition the input data into first input data and second input data;
an in-memory computing circuit comprising an analog crossbar array configured to perform a first multiply-accumulate (MAC) operation based on the first input data and the weight data; and
a digital operation circuit configured to perform a second MAC operation based on the second input data and the weight data.

2. The neural network apparatus of claim 1, wherein
the input data comprises partition information, the partition information indicating a unit and a criterion for partitioning the input data, and
the at least one control circuit is configured to perform the input data into the first input data and the second input data, based on the partition information.

3. The neural network apparatus of claim 2, wherein
the input data is partitioned into tile units, and the at least one control circuit is configured to classify the partitioned input data into the first input data or the second input data, based on criticality of the tile units, indicating whether each of the tiles unit belongs to a region of interest (ROI).

4. The neural network apparatus of claim 2, wherein
the input data is partitioned into layer units, and the at least one control circuit is configured to classify the partitioned input data into the first input data or the second input data, based on sensitivity of the layer units.

5. The neural network apparatus of claim 2, wherein
the input data is partitioned into bit units, and the at least one control circuit is configured to classify the partitioned input data into the first input data or the second input data, based on significance of the bit units, indicating how close each of the bit units is to a most significant bit (MSB) and a least significant bit (LSB) of the bit units.

6. The neural network apparatus of claim 1, wherein
the at least one control circuit is configured to partition the weight data into first weight data corresponding to the first input data and second weight data corresponding to the second input data,
the in-memory computing circuit is configured to perform the first MAC operation using the input data and the first weight data, and
the digital operation circuit is configured to perform the second MAC operation using the input data and the second weight data.

7. The neural network apparatus of claim 1, wherein
the analog crossbar array comprises a plurality of row lines, a plurality of column lines intersecting the plurality of row lines, and a plurality of memory cells arranged at intersections of the plurality of row lines and the plurality of column lines, and
the in-memory computing circuit is configured to store, in the plurality of memory cells, a result of the first MAC operation performed.

8. The neural network apparatus of claim 7, wherein
the analog crossbar array is configured to perform the first MAC operation at least once on each of the plurality of memory cells, and
the in-memory computing circuit is configured to store, in the plurality of memory cells, the result of the first MAC operation performed at least once.

9. The neural network apparatus of claim 7, wherein
the analog crossbar array is configured to perform the first MAC operation on the plurality of memory cells by using charges, and
the in-memory computing circuit is configured to store the result of the first MAC operation as multiple bits, in each memory cell.

10. The neural network apparatus of claim 7, further comprising
an analog-to-digital converter (ADC) configured to convert the result of the first MAC operation stored in the plurality of memory cells, into a digital signal.

11. The neural network apparatus of claim 1, wherein the at least one control circuit is configured to generate output data by combining a result of the first MAC operation with a result of the second MAC operation.

12. The neural network apparatus of claim 11, wherein
when the input data is partitioned into tile units or layer units,
the at least one control circuit is configured to generate the output data by normalizing the result of the first MAC operation and the result of the second MAC operation.

13. The neural network apparatus of claim 11, wherein
when the input data is partitioned into bit units,
the at least one control circuit is configured to generate the output data by performing a shift operation and an addition operation on the result of the first MAC operation and the result of the second MAC operation.

14. The neural network apparatus of claim 1, wherein
the digital operation circuit is configured to perform the second MAC operation based on a look-up table in which results of multiplication operation corresponding to the second input data and the weight data are stored in advance.

15. A method of operating a neural network apparatus, the method comprising:
receiving input data and weight data from at least one memory;
partitioning the input data into first input data and second input data;
performing a first multiply-accumulate (MAC) operation based on the first input data and the weight data, by using an analog crossbar array; and
performing a second MAC operation based on the second input data and the weight data, by using a digital operation circuit.

16. The method of claim 15, wherein
the input data comprises partition information, the partition information indicating a unit and a criterion for partitioning the input data, and
the partitioning the input data into the first input data and the second input data comprises partitioning the input data into the first input data and the second input data, based on the partition information.

17. The method of claim 15, wherein
the analog crossbar array comprises a plurality of row lines, a plurality of column lines intersecting the plurality of row lines, and a plurality of memory cells arranged at intersections of the plurality of row lines and the plurality of column lines, and
the performing of the first MAC operation using the first input data and the weight data comprises:
performing the first MAC operation at least once on each of the plurality of cells; and
storing a result of the first MAC operation performed at least once, in each of the plurality of cells.

18. The method of claim 15, further comprising generating output data by combining a result of the first MAC operation with a result of the second MAC operation.

19. The method of claim 18, wherein
when the input data is partitioned into tile units or layer units,
the generating of the output data comprises normalizing the result of the first MAC operation and the result of the second MAC operation.

20. The method of claim 18, wherein
when the input data is partitioned into bit units,
the generating of the output data comprises performing a shift operation and an addition operation on the result of the first MAC operation and the result of the second MAC operation.
